(19) United States
(12) Patent Application Publication
(10) Pub. No.: US 2014/0222559 A1
(43) Pub. Date: Aug. 7, 2014

(54) METHOD AND SYSTEM OF CUSTOMER LEVEL TRANSACTION ANALYTICS ACROSS MERCHANT SITES

(71) Applicants: Yigit CAGLAYAN, Etiler Istanbul (TR); Caroline Haines, London (GB); Stephen Elder, Dublin (IE); Guilaume Degrijse, Isieres (BE); John Jude Allen, Dublin (IE); Eamon Doyle, Dublin (IE)

(72) Inventors: Yigit CAGLAYAN, Etiler Istanbul (TR); Caroline Haines, London (GB); Stephen Elder, Dublin (IE); Guilaume Degrijse, Isieres (BE); John Jude Allen, Dublin (IE); Eamon Doyle, Dublin (IE)

(73) Assignee: MasterCard International Incorporated, Purchase, NY (US)

(21) Appl. No.: 13/757,878

(22) Filed: Feb. 4, 2013

(51) Int. Cl. G06Q 30/02

(52) U.S. Cl. CPC G06Q 30/0269
USPC 705/14.53; 709/224

(57) ABSTRACT

A method for reporting a consumer profile includes: storing offline financial transaction data involving at least two merchants, each transaction associated with a consumer; receiving an information request, the request including a consumer identifier; identifying browsing information associated with the consumer; analyzing the browsing information and the transactions associated with the consumer to identify a profile; and transmitting the profile to a merchant. A method for displaying a customized web page includes: storing browsing data associated with a consumer; receiving a web page request; identifying the consumer identifier; transmitting an information request, the request including the consumer identifier; receiving offline transaction information for transactions involving the consumer and at least two merchants; analyzing the browsing data and the transaction information to identify a profile; customizing the web page data based on the profile; and transmitting the customized web page data to the consumer for display.

### FIELD

The present disclosure relates to the processing of consumer profiles, specifically the determining of consumer level transaction analytics using both online data and offline transaction data to build consumer profiles.

### BACKGROUND

Advertising is a cornerstone of business development for many merchants, manufacturers, and retailers. Prior to the prevalence of the Internet, traditional print advertising often included taking out advertisements in newspapers and magazines, or sending mailers to groups of consumers. Other forms of advertising included advertising on the radio or on television through commercials. In order to increase the success rate of advertisements, advertisers would often seek demographic information for the various newspaper and magazine subscribers, radio listeners, and television viewers. Many advertisers would select advertising channels and venues based on the demographic information as related to their ideal audience. However, because the audiences are so broad, and the demographic information not as easily gathered or defined, advertisers could often find themselves advertising to consumers with a low success rate.

As the Internet started to be used more and more by consumers, advertisers started to turn their attention more and more to the Internet. The technology of the Internet was a benefit to advertisers, as it enabled consumers to allow their behavior to be monitored on an individual or near individual level, such as by capturing browsing habits, online shopping habits, and the like. This, in combination with web pages being customizable for individual visitors, allowed for merchants and manufacturers to communicate directly with their ideal consumers, resulting in an increase in success rate and a decrease in expense.

However, Internet advertising can still face as many problems as traditional forms of advertisement. Many consumers may browse websites, but then prefer to purchase a product in a brick and mortar store, such as to avoid shipping and waiting for the product, or may be accustomed to making certain purchases in a physical store rather than online, such as with groceries. Internet advertising only takes into account the activity of the consumer on the Internet, without regard to their shopping at brick and mortar stores. Similarly, other forms of advertisement may consider the consumer's shopping habits, such as a store advertising to a loyalty customer, but may ignore that same consumer's Internet browsing and transacting habits.

Thus, there is a need for a technical solution in the form of a system that is capable of using both physical transaction data and Internet behavior information in order to provide a more detailed and comprehensive consumer profile to advertisers.

### SUMMARY

The present disclosure provides a description of a systems and methods for reporting a consumer profile or keyword data to a merchant, and customizing a web page presented to a consumer based on their consumer profile.

A method for reporting a consumer profile to a merchant includes: storing, in a database, a plurality of transaction data entries, wherein each transaction data entry is associated with a consumer and includes a plurality of financial transactions, the plurality of financial transactions involving at least two merchants and including offline transactions; receiving, from a merchant, a request for information, wherein the request for information includes at least a consumer identifier corresponding to the consumer; identifying, by a processing device, browsing information associated with the consumer, wherein the browsing information includes information corresponding to at least two merchant web sites; analyzing, by the processing device, the browsing information and the transaction data entry associated with the consumer to identify a consumer profile associated with the consumer; and transmitting, by a transmitting device, the consumer profile to the merchant.

A method for displaying a customized web page to a user includes: storing, in a web database, web page data for a web page; storing, in a tracking database, browsing data for a consumer, wherein the browsing data includes at least a consumer identifier and data corresponding to at least two merchant web sites; receiving, by a receiving device, a request for the web page from the consumer; identifying, by a processing device, the consumer identifier; transmitting, by a transmitting device, a request for transaction information, wherein the request for transaction information includes at least the consumer identifier; receiving, by the receiving device, transaction information for a plurality of financial transactions involving the consumer, wherein the plurality of financial transactions involve at least two merchants and includes offline transactions; analyzing, by the processing device, the browsing data and the transaction information associated with the consumer to identify a consumer profile; customizing the web page data based on the identified consumer profile; and transmitting the customized web page data to the consumer for display.

A method for reporting consumer keyword data to a merchant includes: storing, in a database, a plurality of consumer profiles, wherein each consumer profile includes at least a consumer identifier; receiving, by a receiving device, an initial data request for a web page originating from a user computer, wherein the data request includes at least a redirecting address; transmitting, to the user computer, data, wherein the data generates a browsing information file in the user computer and redirects the user computer to the redirecting address, and wherein the browsing information file includes a consumer identifier for a specific consumer profile in the plurality of consumer profiles; receiving, by the receiving device, keyword data; storing, in the specific consumer profile, the received keyword data; receiving, by the receiving device, a subsequent data request from the user computer, wherein the subsequent data request includes at least a merchant identifier; identifying, by a processing device, the browsing information file in the user computer; and transmitting, to a merchant associated with the merchant identifier, the keyword data included in the specific consumer profile.

A system for reporting a consumer profile to a merchant includes a database, a receiving device, a processing device, and a transmitting device. The database is configured to store a plurality of transaction data entries, wherein each transaction data entry is associated with a consumer and includes a plurality of financial transactions, the plurality of financial transactions involving at least two merchants and including offline transactions. The receiving device is configured to receive, from a merchant, a request for information, wherein the request for information includes at least a consumer identifier corresponding to the consumer. The processing device is configured to identify browsing information associated with the consumer, wherein the browsing information includes information corresponding to at least two merchant web sites, and analyze the browsing information and the transaction data entry associated with the consumer to identify a consumer profile associated with the consumer. The transmitting device is configured to the consumer profile to the merchant.

A system for displaying a customized web page to a user includes a web database, a tracking database, a receiving device, a transmitting device, and a processing device. The web database is configured to store web page data for a web page. The tracking database is configured to store browsing data for a consumer, wherein the browsing data includes at least a consumer identifier and data corresponding to at least two merchant web sites. The receiving device is configured to receive a request for the web page from the consumer. The processing device is configured to identify the consumer identifier. The transmitting device is configured to transmit a request for transaction information, wherein the request for transaction information includes at least the consumer identifier. The receiving device is further configured to receive transaction information for a plurality of financial transactions involving the consumer, wherein the plurality of financial transactions involve at least two merchants and includes offline transactions. The processing device is further configured to: analyze the browsing data and the transaction information associated with the consumer to identify a consumer profile; customize the web page data based on the identified consumer profile; and cause the transmitting device to transmit the customized web page data to the consumer for display.

A system for reporting consumer keyword data to a merchant includes a database, a receiving device, a transmitting device, and a processing device. The database is configured to store a plurality of consumer profiles, wherein each consumer profile includes at least a consumer identifier. The receiving device is configured to receive an initial data request originating from a user computer, wherein the initial data request includes at least a redirecting address. The transmitting device is configured to transmit, to the user computer, data, wherein the data generates a browsing information file in the user computer and redirects the user computer to the redirecting address, and wherein the browsing information file includes a consumer identifier for a specific consumer profile in the plurality of consumer profiles. The processing device is configured to: cause the receiving device to receive keyword data; store, in the specific consumer profile, the received keyword data; cause the receiving device to receive a subsequent data request originating from the user computer, wherein the subsequent data request includes at least a merchant identifier; and identify the browsing information file in the user computer. The transmitting device is further configured to transmit, to a merchant associated with the merchant identifier, the keyword data included in the specific consumer profile.

### BRIEF DESCRIPTION OF THE DRAWING FIGURES

Exemplary embodiments are best understood from the following detailed description when read in conjunction with the accompanying drawings. Included in the drawings are the following figures:

FIG. 1 is a block diagram illustrating a system for processing consumer profiles and presenting customized web page data in accordance with exemplary embodiments.

FIG. 2 is a block diagram illustrating a processing server for use in the system of FIG. 1 in accordance with exemplary embodiments.

FIG. 3 is a block diagram illustrating a web hosting server for use in the system of FIG. 1 in accordance with exemplary embodiments.

FIG. 4 is a block diagram illustrating a transaction database of the processing server of FIG. 2 in accordance with exemplary embodiments.

FIG. 5 is a block diagram illustrating a profile database of the processing server of FIG. 2 in accordance with exemplary embodiments.

FIGS. 6A-6B are flow diagrams illustrating a method for reporting a consumer profile based on Internet and physical activity with exemplary embodiments.

FIGS. 7A-7B are flow diagrams illustrating a method for presenting a consumer with a customized web page in accordance with exemplary embodiments.

FIG. 8 is a block diagram illustrating system architecture of a computer system in accordance with exemplary embodiments.

FIG. 10 is a flow chart illustrating an exemplary method for reporting a consumer profile to a merchant in accordance with exemplary embodiments.

FIG. 11 is a flow chart illustrating an exemplary method for displaying a customized web page to a user in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Processing a Consumer Profile and Customizing a Web Page

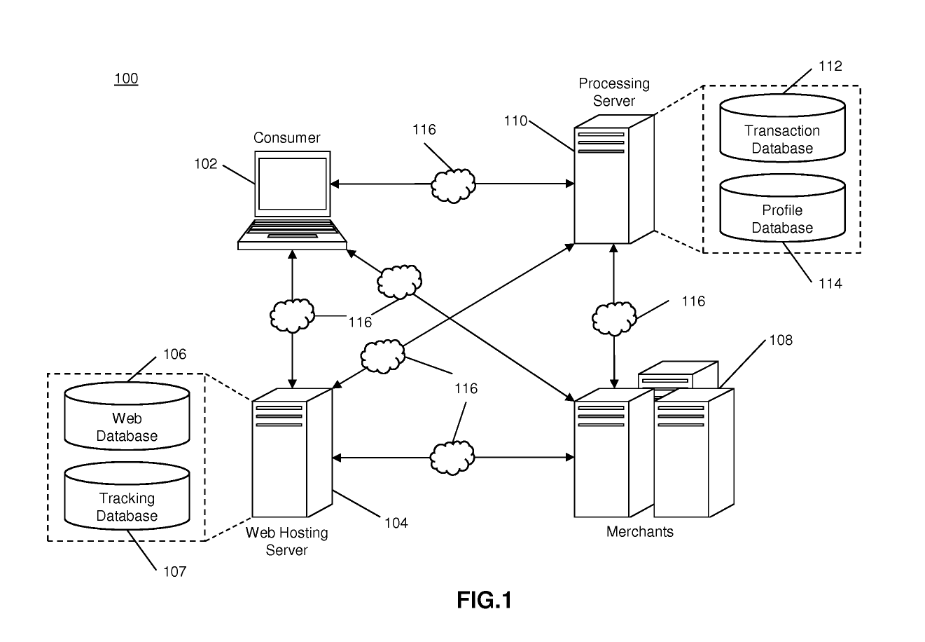

FIG. 1 illustrates a system 100 for processing a consumer profile if a consumer and customizing a web page presented to the consumer based on the profile. Several of the components of the system 100 may communicate via a network 116. The network 116 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art.

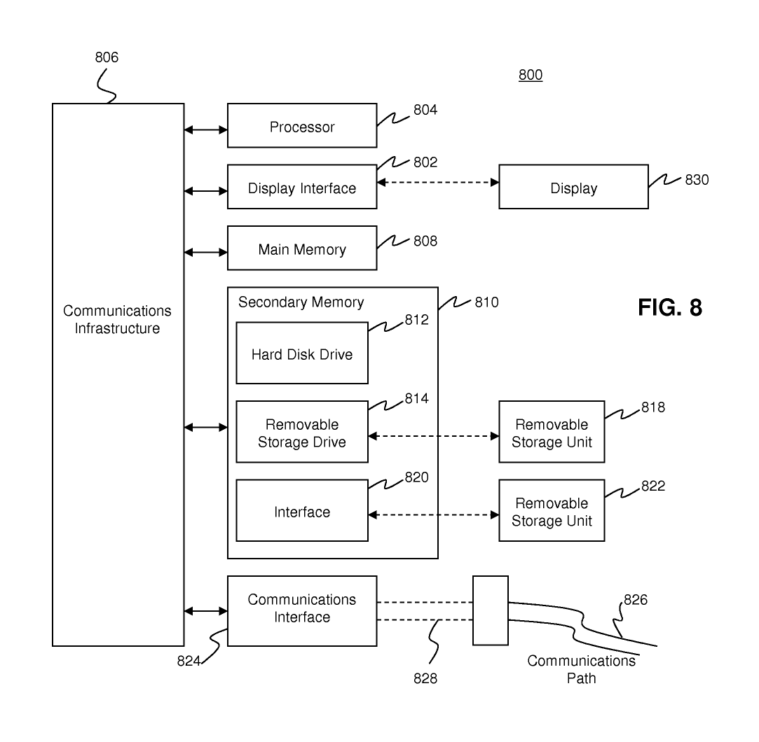

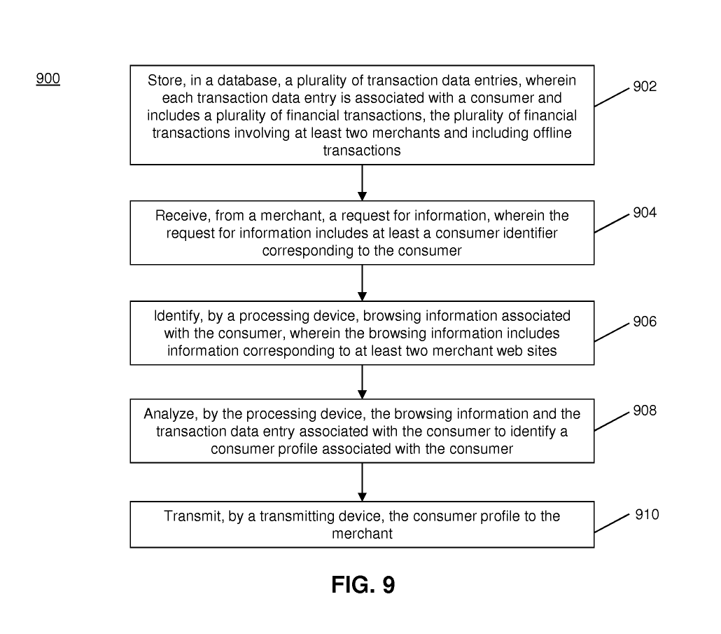

The system 100 may include a consumer 102. The consumer 102 may be a consumer device that may be configured to connect to the Internet and perform functions related thereto, such as browsing, transacting, social networking, etc. The consumer 102 may be any device suitable for performing the functions as disclosed herein, such as the computer system illustrated in FIG. 8, discussed in more detail below, such as a desktop computer, a laptop computer, a notebook computer, a tablet, a smart phone, etc.

The consumer 102 may navigate to a merchant web page, which may be displayed on a display of the consumer 102. The merchant web page may be hosted by a web hosting server 104. The web hosting server may store the web page data in a web database 106. The web page data may be received by, or stored and transmitted at the direct of, one of a plurality of merchants 108. It will be apparent to persons having skill in the relevant art that, although the system 100 is illustrated as including a single web hosting server 104, each of the merchants 108 may operate or utilize a plurality of separate or combined web hosting servers.

The web hosting server 104 may transmit the web page data included in the web database 106 to the consumer 102 for display, as discussed in more detail below. The web hosting server 104 may also track the browsing habits of the consumer 102 by methods as disclosed herein, such as using first- or third-party cookies. The web hosting server 104 may store data relevant to the tracking, such as analysis or generated data or the cookies themselves, in a tracking database 107. Tracking the browsing habits of the consumer 102 may include monitoring web pages visited, time spent at each web page, financial transactions initiated, categories of web pages visited, etc. In an exemplary embodiment, the consumer 102 may opt-in to a service that tracks their browsing habits.

The web page data displayed at the consumer 102 may include customizable web page data. The customizable web page data may be data included in a web page that is customizable based on the consumer 102. Customizable web page data may include advertisements, links, images, text, audio files, or any other type of data that may be included in a web page that may be customized based on the visitor. The customizable web page data may be selected by the corresponding merchant 108 of the web page, or may be selected by the web hosting sever 104, such as based on guidelines provided by the merchant 108. The selection of customizable web page data may be based on tracking information and transaction information, as discussed in more detail herein.

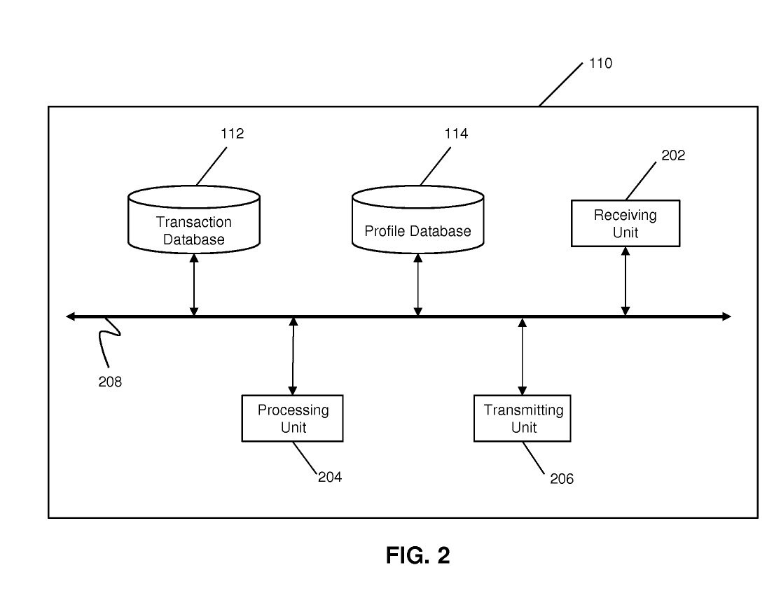

The system 100 may also include a processing server 110. The processing server 110 may be any type of server suitable for performing the functions as disclosed herein, such as the systems illustrated in FIG. 2 or 8. The processing server 110 may be configured to store transaction data for a plurality of financial transactions including a plurality of consumers, such as the consumer 102. In an exemplary embodiment, the transaction data may include offline transaction data. The transaction data may be stored in a transaction database 112, discussed in more detail below. In one embodiment, the processing server 110 may be a financial transaction processing agency (e.g., MasterCard®, VISA®, etc.) and may store transaction data corresponding to processed transactions including the consumer 102. In an exemplary embodiment, the explicit consent of the consumer 102 may be obtained prior to the capturing and/or receiving of transaction data including the consumer 102.

The processing server 110 may also be configured to communicate with the web hosting server 104 to receive the tracking data corresponding to the consumer 102 and stored in the tracking database 107. In one embodiment, the tracking database 107 may be a part of the processing server 110, which may be configured to identify consumer browsing behavior in place or, or in addition to, the web hosting server 104. The processing server 110 may then analyze the transaction data and tracking data, as discussed in more detail below, and build a consumer profile of the consumer 102. The processing server 110 may store the consumer profile in a profile database 114. The profile database 114 may include a plurality of consumer profiles, each consumer profile including a plurality of analytics and other data, which may be based on the specific application of the profile. The profile database 114 is discussed in more detail below and may include at least an interest index, frequency of clicks, price sensitivity, shipping cost sensitivity, discretionary spending, and affluence index.

The processing server 110 may be further configured to present the consumer profile for the consumer 102 to the merchant 108. In one embodiment, the processing server 110 may present consumer profiles to the merchant 108 based on a request for the specific consumer profiles. In another embodiment, the processing server 110 may identify consumer profiles based on criteria (e.g., specific analytics, values, etc.) and present those identified profiles to the merchant 108.

The merchant 108 may receive the consumer profile for the consumer 102 and may, based on the information included in the consumer profile, customize web page data displayed to the consumer 102. In some embodiments, the merchant 108 may provide the consumer profiles to the web hosting server 104 and may provide criteria for selection and display of customized web page data based on the consumer profile for each visitor of the merchant web page.

### Processing Server

FIG. 2 illustrates an embodiment of the processing server 110. The processing server 110 may include the transaction database 112, the profile database 114, a receiving unit 202, a processing unit 204, and a transmitting unit 206. Each of the components may be configured to communicate via a bus 208. Suitable types and configurations of the bus 208 will be apparent to persons having skill in the relevant art.

The transaction database 112 may be configured to store transaction data for a plurality of financial transactions between the consumer 102 and the plurality of merchants 108, as discussed in more detail below. The transaction data may include details for the financial transaction, such as time and/or date, location, transaction amount, etc. as will be apparent to persons having skill in the relevant art. In one embodiment, the transaction data may be received by the receiving unit 202, and stored in the transaction database 112 by the processing unit 204. In another embodiment, the processing unit 204 may be configured to process authorization requests for financial transactions and may store the transaction data for the processed transaction in the transaction database 112. In an exemplary embodiment, the transaction data may be offline transaction data.

The receiving unit 202 may be configured to receive (e.g., from the merchant 108) a request for a consumer profile. The request for a consumer profile may include a consumer identifier corresponding to the consumer 102. The processing unit 204 may be configured to identify transactions corresponding to the consumer 102 in the transaction database 112. The transmitting unit 206 may be configured to transmit a request to the web hosting server 104 for tracking data corresponding to the consumer 102. The receiving unit 202 may receive the tracking data from the web hosting server 104 in response to the request.

The processing unit 204 may then analyze the transaction data and the tracking data to determine a consumer profile for the consumer 102. The consumer profile may include behavioral data of the consumer based on the analyzed information. Data included in the consumer profile will be apparent to persons having skill in the relevant art and may include interest index, frequency of clicks, price sensitivity, shipping cost sensitivity, discretionary spending, affluence index, propensity to spend, merchant interest, industry interest, manufacturer preferences, etc. The processing unit 204 may store the consumer profile in the profile database 114. The transmitting unit 206 may be configured to transmit the consumer profile for the consumer 102 to the merchant 108, or to the web hosting server 104 on behalf of or at the instruction of the merchant 108.

### Web Hosting Server

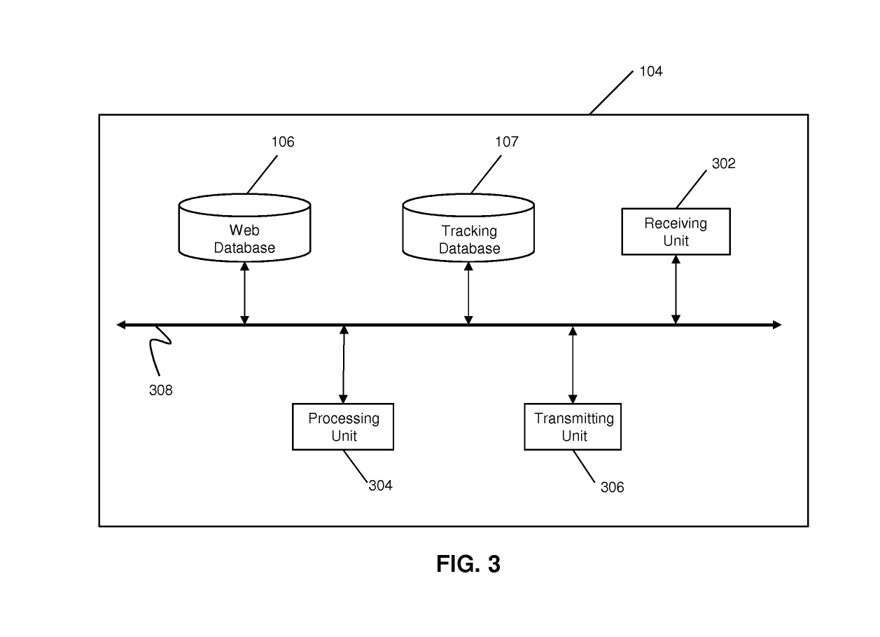

FIG. 3 illustrates an embodiment of the web hosting server 104. The web hosting server 104 may include the web database 106, the tracking database 107, a receiving unit 302, a processing unit 304, and a transmitting unit 306. Each of the components may be configured to communicate via a bus 308. Suitable types and configurations of the bus 308 will be apparent to persons having skill in the relevant art.

The web database 106 may be configured to store web page data for a merchant web page. The web page data may be received by the receiving unit 302, such as from the merchant 108 for a web page corresponding to the merchant 108, or may be generated by the processing unit 304. The receiving unit 302 may be configured to receive a page request for a web page. Suitable configurations of the page request will be apparent to persons having skill in the relevant art, and may comply with the hypertext transfer protocol (HTTP). The processing unit 304 may identify the corresponding web page data stored in the web database 106, and the transmitting unit 306 may be configured to transmit the web page data to the consumer 102 for display on a display device of the consumer 102 in response to the page request.

The processing unit 304 may be configured to monitor the browsing habits of the consumer 102, such as by monitoring the receiving of and response to page requests between the web hosting server 104 and the consumer 102. The processing unit 304 may store data related to the browsing habits in the tracking database 107. Data related to the browsing habits may include first-party cookies, third-party cookies, data received from third party monitoring services, etc. Suitable methods for monitoring the browsing habits of consumers online will be apparent to persons having skill in the relevant art.

The receiving unit 302 may be further configured to receive a request for tracking data (e.g., from the processing server 110), wherein the request includes at least a consumer identifier (e.g., associated with the consumer 102). The processing unit 304 may identify, in the tracking database 107, tracking data associated with the consumer 102 based on the consumer identifier. The transmitting unit 306 may then transmit the identified tracking data to the processing server 110 in response to the request.

In one embodiment, the receiving unit 302 may be configured to receive customizable web page data for display to the consumer 102. In a further embodiment, the customizable web page data may be received in response to a request including a consumer identifier of the consumer 102 transmitted (e.g., via the transmitting unit 306) to the merchant 108 following the consumer 102 visiting the web page. In an alternative further embodiment, the customizable web page data may be received by the receiving unit 302 in advance and identified by the processing unit 304 at the time the consumer 102 visits the web page.

In another embodiment, the receiving unit 302 may receive at least the consumer profile associated with the consumer 102 and may further receive criteria for selection of customizable web data from the merchant 108. The processing unit 304 may analyze the received consumer profile and, using the received criteria, may identify customizable web page data to be displayed to the consumer 102. The processing unit 304 may update the web page data included in the web database 106, and the transmitting unit 306 may transmit the web page data including the customizable data to the consumer 102 for display.

In some embodiments, the web hosting server 104 may be included as part of, or operate on behalf of, the processing server 110. In such an embodiment, the web database 106 may be configured to host web page data on behalf of the processing server 110. The processing server 110 (e.g., using the web hosting sever 104) may use a browsing information file, such as a cookie, to track the consumer 102 as they browse on multiple merchant web sites corresponding to at least two merchants 108, as explained below. In an exemplary embodiment, the web hosting server 104 may monitor the consumer's browsing without obtaining any personally identifiable information (e.g., the browsing information file may be kept anonymous).

In such an embodiment, the receiving unit 302 of the web hosting server 104 may be configured to receive an initial data request. The initial data request may come from a first merchant 108, but may originate from the consumer 102. If the consumer 102 is not already associated with a multiple merchant cookie, the initial data request may include at least a redirecting address (e.g., a URL for a web page corresponding to the first merchant 108). The processing unit 304 may identify if a browsing information file already exists in the consumer 102, such as by transmitting web page data to identify the browsing information file. If the processing unit 304 determines that no such file already exists in the consumer 102, then the web hosting server 104 may transmit data to the consumer 102 to generate a browsing information file. Methods for identifying and/or generating browsing information files (e.g., cookies) on a consumer device will be apparent to persons having skill in the relevant art. For example, the initial data request may be a page request, and the data transmitted to the consumer 102 may be web page data with code designed to cause the consumer 102 to generate the browsing information file and redirect the browsing program to the redirecting address.

The browsing information file in the consumer 102 may include at least a consumer identifier corresponding to the consumer 102. In one embodiment, a consumer profile including the consumer identifier may be stored in the profile database 114. The transmitting unit 306 may be configured to transmit the data to the consumer 102 that generates the browsing information file, and may also transmit data to the consumer 102 that redirects a web browsing application of the consumer 102 to the redirect address included in the first page request. For example, the consumer 102 may be redirected to a web page of the first merchant 108 after creation of the browsing information file without any interruption in the consumer's browsing experience.

The receiving unit 302 may be further configured to receive keyword data from the first merchant 108. The keyword data may include keywords identified by the first merchant 108 based on at least one web page visited by the consumer 102. Methods for identifying keyword data on visited web pages will be apparent to persons having skill in the relevant art, such as web page code (e.g., JavaScript) configured to transmit predetermined keywords to the web hosting server 104 and/or the processing server 110 associated with the consumer identifier included in the browsing information file once the web page has been accessed. In one embodiment, the processing unit 304 may store the received keyword data in the consumer profile associated with the browsing information file in the profile database 114.

The receiving unit 302 may also be configured to receive a subsequent data request from a second merchant 108 and/or originating from the consumer 102. The subsequent data request may include at least a merchant identifier, such as the address (e.g., URL) from which the subsequent data request is received. The processing unit 304 may identify (e.g., via web page data transmitted to the consumer 102) that a browsing information file already exists on the consumer 102. The processing unit 304 may identify the consumer identifier included in the browsing information file and may then identify a specific consumer profile in the profile database 114. The transmitting unit 306 may then transmit the keyword data included in the specific consumer profile to the second merchant 108. The transmitting unit 306 may be further configured to transmit web page data to the consumer 102 to redirect the consumer 102 to the originally requested web page (e.g., without a visible interruption in the consumer's browsing experience). In some embodiments, the subsequent data request may be a web page request.

In some embodiments, the keyword data may be analyzed (e.g., by the processing unit 304 or the processing server 110) to identify a consumer profile for the consumer 102. In a further embodiment, the consumer profile may include at least one profiling segment or indicia.

It will be apparent to persons having skill in the relevant art that this method for identifying browsing information of the consumer 102 may be beneficial for identifying the browsing habits of one consumer across multiple merchant websites. For example, the consumer 102 may visit a first web page, at which time a browsing information file is created on the consumer 102. The first web page may be a retail shopping page for cameras and other photography items. The web page may include code to transmit keyword data (e.g., photography, camera, digital camera, photographs, etc.) to the web hosting server 104 with the consumer 102 identified based on the browsing information file. The web hosting server 104 may store the keyword data as associated with the browsing information file in the consumer 102. The consumer 102 may then visit a second web page. The page may identify that there already exists a browsing information file in the consumer 102, and in response, the keyword data for the consumer 102 may be transmitted to the merchant 108 (e.g., or the web hosting server 104) for the second web page. The web page may then be modified based on the keyword data as discussed herein and will be apparent to persons having skill in the relevant art, such as displaying photography related items in the previous example.

### Transaction and Profile Databases

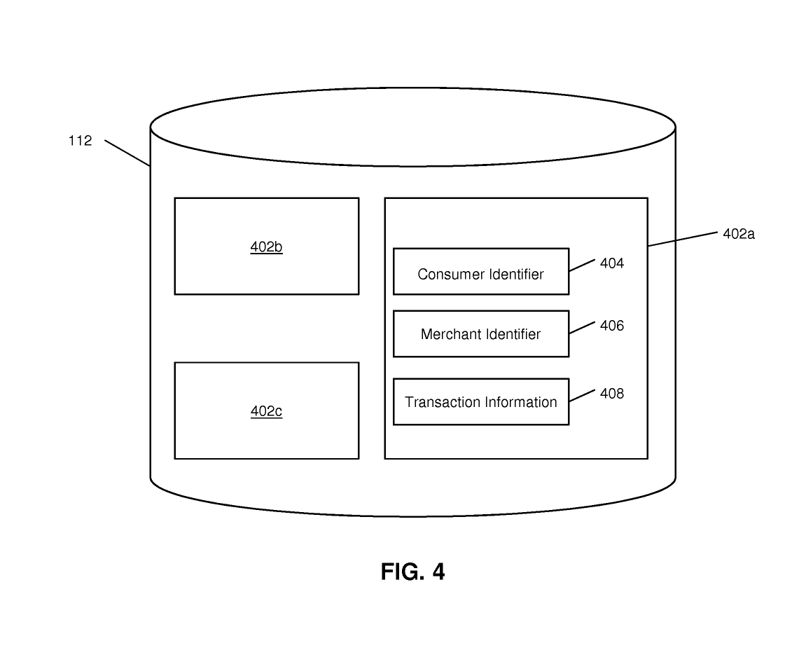

FIG. 4 illustrates the transaction database 112 of the processing server 110 for use in the system 100. The transaction database 112 may include a plurality of financial transactions 402, illustrated as financial transactions 402a, 402b, and 402c in FIG. 4. Each of the financial transactions 402 may include at least a consumer identifier 404, a merchant identifier 406, and transaction information 408. In one embodiment, each of the financial transactions 402 is an offline transaction.

The consumer identifier 404 may be a value suitable for identifying the financial transaction as associated with a unique consumer (e.g., the consumer 102). The consumer identifier 404 may be a financial account number (e.g., for the account used to fund the financial transaction 402), an e-mail address, a phone number, a number generated or identified by the processing server 110, or any other value suitable for performing the functions as disclosed herein as will be apparent to persons having skill in the relevant art. The merchant identifier 406 may be a value suitable for identifying a merchant (e.g., the merchant 108) as participating in the financial transaction 402. In an exemplary embodiment the merchant identifier 406 may be a merchant identification number (MID) or a merchant code assigned to the merchant 108 by a financial transaction processing agency.

The transaction information 408 may be transaction details for the financial transaction 402 suitable for performing the functions as disclosed herein. For example, the transaction information may include time and/or date of the transaction, transaction amount, products included in the transaction, location of the transaction (e.g., online, geographic location, etc.), merchant industry of the merchant 108, pricing for individual products, categories for individual products, etc. Additional transaction information will be apparent to persons having skill in the relevant art.

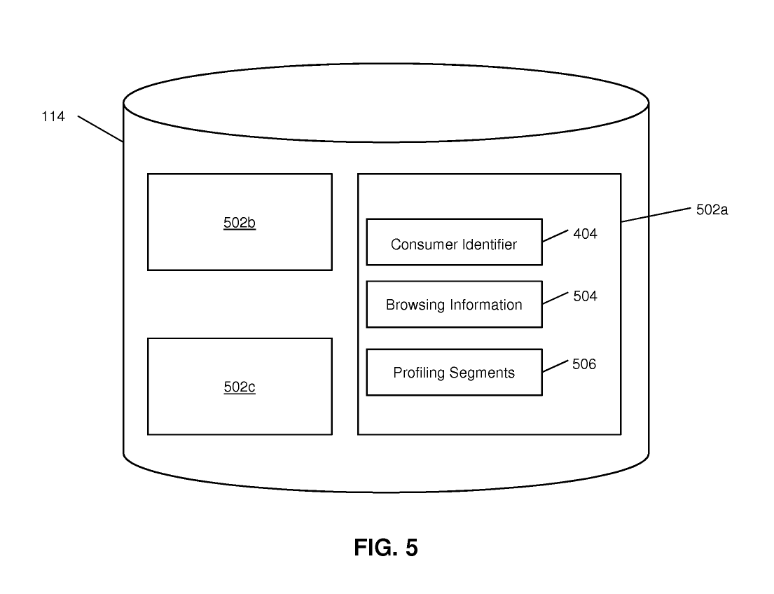

FIG. 5 illustrates the profile database 114 of the processing server 110. The profile database 114 may include a plurality of consumer profiles 502, illustrated as consumer profiles 502a, 502b, and 502c in FIG. 5. Each consumer profile 502 may include the consumer identifier 404, browsing information 504, and profiling segments 506.

The consumer identifier 404 may be the same consumer identifier 404 included in the transaction database 112, which may be used to associate the consumer profile 502 with the consumer 102 and to identify the financial transactions 402 in the transaction database 112 for use in building the consumer profile 502. The browsing information 504 may include the tracking data received from the web hosting server 104, which may include online behavioral information associated with the consumer 102, such as browsing habits, online transactions, social networking information, etc. In an exemplary embodiment, the consumer 102 may consent to monitoring of behavioral information prior to the reception and storage of the browsing information 504.

The profiling segments 506 may include data generated, identified, or determined by the processing unit 204 of the processing server 110 corresponding to the consumer 102 based on the analyzed transaction information 408 and browsing information 504. The profiling segments 506 may include at least interest index, frequency of clicks, price sensitivity, shipping cost sensitivity, discretionary spending, affluence index, propensity to spend, merchant interest, industry interest, manufacturer preferences, etc. Segments that may be included in the consumer profile 502, which may be used by the merchant 108 or the web hosting server 104 to identify customizable web page data useful for advertising to the consumer 102, will be apparent to persons having skill in the relevant art.

In one embodiment, the consumer profile 502 (e.g., and further the browsing information 504) may further include keyword data. The keyword data may include a plurality of keywords and/or data associated with each keyword of a plurality of keywords. The keyword data may be based on the browsing of the consumer 102 associated with the consumer profile 502. For example, if the consumer 102 visits a web page regarding cameras and photography equipment, the keyword data may include corresponding keywords or values that identify that the consumer 102 has visited a web page including such keywords.

Data stored in the web database 106, the tracking database 107, the transaction database 112, and the profile database 114 (the “databases”) may be stored on any type of suitable computer readable media, such as optical storage (e.g., a compact disc, digital versatile disc, Blu-ray disc, etc.) or magnetic tape storage (e.g., a hard disk drive). The databases may be configured in any type of suitable database configuration, such as a relational database, a structured query language (SQL) database, a distributed database, an object database, etc. Suitable configurations and database storage types will be apparent to persons having skill in the relevant art. The databases may each be a single database, or may comprise multiple databases which may be interfaced together (e.g., physically or via a network, such as the network 116).

### Method for Reporting Consumer Profiles

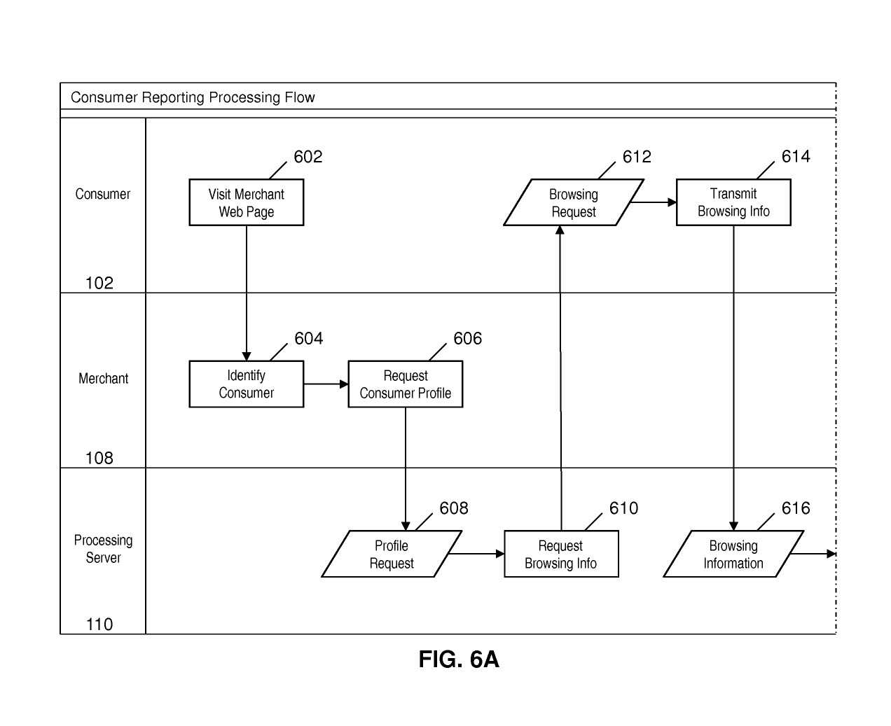

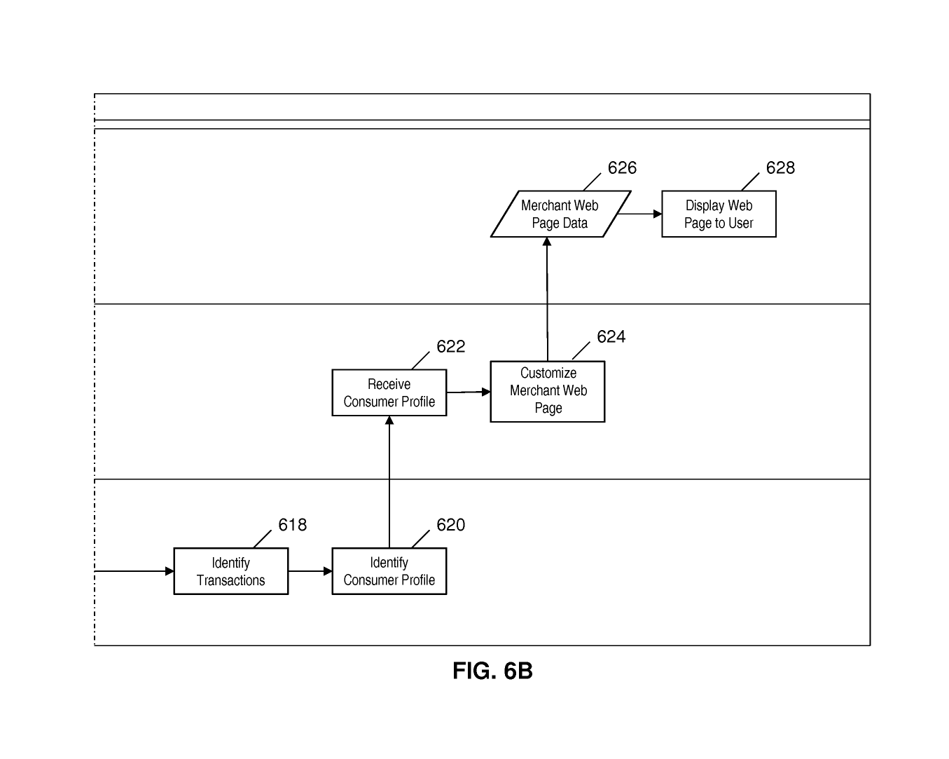

FIGS. 6A and 6B illustrate a method for reporting consumer profiles to merchants using the system 100 of FIG. 1.

In step 602, the consumer 102 may visit a merchant web page, which may be hosted by the web hosting server 104, using a web browsing application or other application or software program with web browsing capability. In step 604, the merchant 108 (e.g., or the web hosting server 104 operating on behalf of the merchant 108) may identify the consumer 102. In one embodiment, the merchant 108 may identify the consumer 102 via cookies. In another embodiment, the merchant 108 may identify the consumer 102 by authenticating the consumer 102, such as by using a login system. In step 606, the merchant 108 may submit a request for a consumer profile to the processing server 110, which may receive the request in step 608. The request for a consumer profile may include at least a consumer identifier (e.g., the consumer identifier 404) associated with the consumer 102. In one embodiment, the request may further include at least one profiling segment or indicia.

In step 610, the processing server 110 may request browsing information from the consumer 102. In step 612, the consumer 102 may receive the browsing information request and, in step 614, transmit the browsing information 504 back to the processing server 110. In one embodiment, the browsing information 504 may be in the form of a first- or third-party cookie, which may be stored on the consumer 102 and viewed, downloaded, and/or accessed by the processing server 110. In some embodiments, the browsing information request may be received and processed by the web hosting server 104 or a third party in place of the consumer 102. In one embodiment, the browsing information 504 may include browsing information corresponding to at least two merchant web sites. In an exemplary embodiment, the browsing information may include keyword data or other information received based on a browsing information file included in the consumer 102. In a further embodiment, the browsing information may be the browsing information file.

In step 616, the processing server 110 may receive the browsing information 504 and then, in step 618, may identify a plurality of financial transactions 402 in which the consumer 102 has participated. The plurality of financial transactions 402 may involve at least two merchants, one of which may be the merchant 108. In one embodiment, the browsing information 504 received by the processing server 110 may include browsing information 504 for the at least two merchants for which the consumer 102 was involved with in the financial transaction data.

In step 620, the processing server 110 may identify a consumer profile (e.g., the consumer profile 502) corresponding to the consumer 102. It will be apparent to persons having skill in the relevant art that the identification of a consumer profile 502 may include determining a consumer profile 502 based on the browsing information and/or transaction data, or generating a consumer profile 502 by using the browsing information and/or transaction data. In embodiments where the consumer profile 502 may be based on browsing information and not transaction data, step 618 may be optional. The identified consumer profile 502 may include at least one profiling segment 506 or indicia. In one embodiment, the at least one profiling segment 506 or indicia may include at least one of: interest index, frequency of clicks, price sensitivity, shipping cost sensitivity, discretionary spending, and affluence index. In some embodiments, the consumer profile 502 may include the at least one profiling segment 506 or indicia included in the profile request. In other embodiments, the consumer profile 502 may include spending behaviors for the consumer 102.

In step 622, the processing server 110 may transmit the identified consumer profile to the merchant 108, which may receive the consumer profile. In step 624, the merchant 108 (e.g., or the web hosting server 104) may customize the web page data for the merchant web page based on the received consumer profile (e.g., to display an advertisement based on the profiling segments 506 of the consumer 102). In step 626, the merchant 108 or the web hosting server 104 may transmit the customized web page data to the consumer 102, which may display the customized web page to a user in step 628.

### Method for Customizing Web Page Data

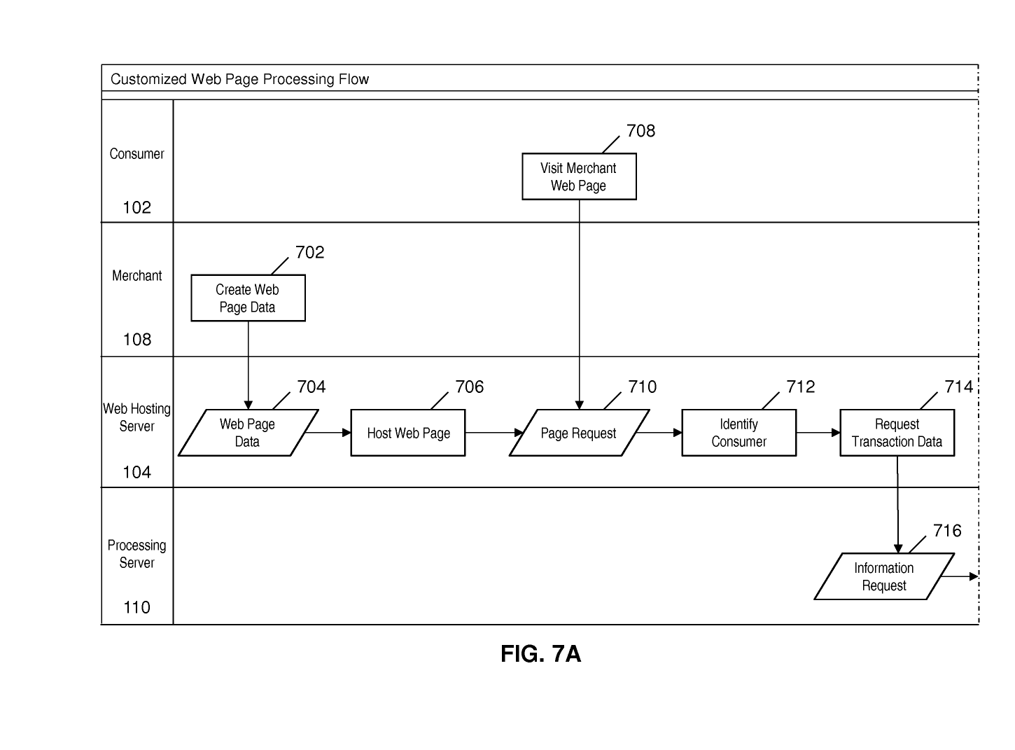

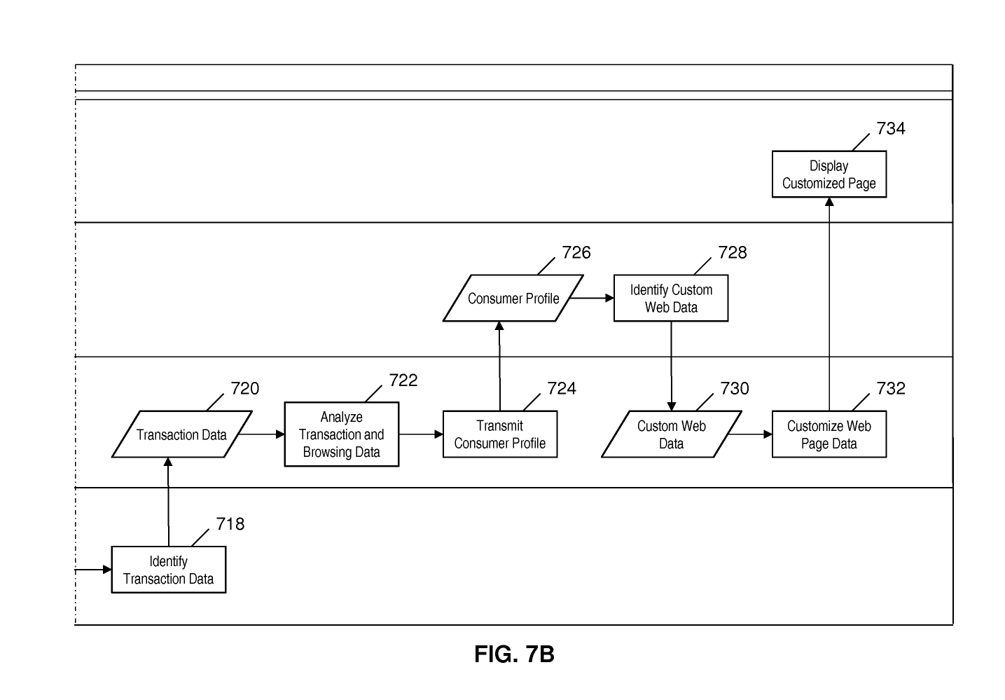

FIGS. 7A and 7B illustrate a method for customizing web page data for a web paged based on a consumer profile using the system 100 of FIG. 1.

In step 702, the merchant 108 may create web page data for a merchant web page. In some embodiments, the merchant 108 may provide a third party (e.g., the web hosting server 104, a web design firm, etc.) with instructions for the merchant web page, who may then create the corresponding web page data. In step 704, the web hosting server 104 may receive the web page data from the merchant 108, which may be stored in the web database 106. In step 706, the web hosting server 104 may host the web page such that it is available for users to visit on the Internet. Methods for hosting a web page will be apparent to persons having skill in the relevant art.

In step 708, the consumer 102 may visit the merchant web page, such as by entering the corresponding web page address (e.g., URL) in a web browser. Visiting the merchant web page may include the consumer 102 submitting a page request to the web hosting server 104, which may receive the page request in step 710. In one embodiment, the page request and transmission thereof may be based on the hypertext transfer protocol (HTTP) standard. In step 712, the web hosting server 104 may identify the consumer 102. In one embodiment, identifying the consumer 102 may include identifying a consumer identifier (e.g., the consumer identifier 404) in the page request. In another embodiment, identifying the consumer 102 may include identifying the consumer identifier 404 in a browsing information file stored on the consumer 102. In yet another embodiment, identifying the consumer 102 may include authenticating the consumer 102 using the web page (e.g., by requesting login information). In an alternative embodiment, the web hosting server 104 may not be able to identify the consumer 102 and may instead identify a consumer identifier 404 to be associated with the consumer 102, and transmit web page data to the consumer 102 to cause the consumer 102 to generate a browsing information file (e.g., a cookie) including the consumer identifier 404.

In step 714, the web hosting server 104 may request transaction data from the processing server 110, which may receive the request in step 716. The transaction data request may include at least the consumer identifier 404 associated with the consumer 102, or other information suitable for identifying financial transactions 402 involving the consumer 102. In step 718, the processing server 110 may identify the financial transactions 402 involving the consumer 102 using the included information. In some embodiments, the identified financial transactions 402 may involve at least two merchants. In a further embodiment, the merchant 108 may be one of the at least two merchants. In an exemplary embodiment, the financial transactions 402 may be offline transactions.

In step 720, the processing server 110 may transmit, and the web hosting server 104 may receive, the transaction data of the identified financial transactions 402. Then, in step 722, the web hosting server 104 may analyze the received transaction data as well as browsing information 506 to identify (e.g., build, determine, etc.) a consumer profile 502 for the consumer 102. In some embodiments, the web hosting server 104 may identify and store the browsing information 506 locally (e.g., in the tracking database 107). In other embodiments, the web hosting server 104 may receive the browsing information 506 for use in identifying the consumer profile 502 from a third party (e.g., a web tracking agency). In one embodiment, the web hosting server 104 may analyze only the browsing information 506 to identify the consumer profile 502. In such an embodiment, it will be apparent to persons having skill in the relevant art that steps 714 to 720 may be optional steps.

In step 724, the web hosting server 104 may transmit the identified consumer profile 502 to the merchant 108, which may receive the profile in step 726. As discussed previously, the consumer profile 502 may include profiling segments 506, such as interest index, frequency of clicks, price sensitivity, shipping cost sensitivity, discretionary spending, and affluence index. In step 728, the merchant 108 may identify custom web data based to be displayed to the consumer 102 (e.g., based on at least one profiling segment 506). In step 730, the merchant 108 may transmit, and the web hosting server 104 may receive, the custom web data. It will be apparent to persons having skill in the relevant art that steps 724 to 730 may be optional. In such an embodiment, the web hosting server 104 may identify the custom web data based on criteria previously set forth by the merchant 108 (e.g., using the profiling segments 506 of the consumer profile 502).

In step 732, the web hosting server 104 may modify the web page data for the merchant web page to include the custom web data. In some embodiments, the customized web page data may be stored in the web database 106. In step 734, the customized web page data may be transmitted to the consumer 102, for display of the custom merchant web page to a user.

### Computer System Architecture

FIG. 8 illustrates a computer system 800 in which embodiments of the present disclosure, or portions thereof, may be implemented as computer-readable code. For example, the consumer 102, the web hosting server 104, the merchants 108, and the processing server 110 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 6A, 6B, 7A, 7B, 9, and 10.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. The processor device 804 may be connected to a communication infrastructure 806, such as a bus, message queue, network (e.g., the network 116), multi-core message-passing scheme, etc. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive, the removable storage unit 818 may be a floppy disk. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

Computer program medium and computer usable medium may refer to memories, such as the main memory 808 and secondary memory 810, which may be memory semiconductors (e.g. DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 6A, 6B, 7A, 7B, 9, and 10, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

### Exemplary Method for Reporting a Consumer Profile to a Merchant

FIG. 9 illustrates a method 900 for reporting a consumer profile (e.g., the consumer profile 502) to a merchant (e.g., the merchant 108).

In step 902, a plurality of transaction data entries (e.g., financial transactions 402) may be stored in a database (e.g., the transaction database 112), wherein each transaction data entry 402 is associated with a consumer (e.g., the consumer 102) and includes a plurality of transactions (e.g., the transaction information 408), the plurality of transactions 408 involving at least two merchants and including offline transactions. In one embodiment, the at least two merchants may include the merchant 108.

In step 904, a request for information may be received from the merchant 108, wherein the request for information includes at least a consumer identifier (e.g., the consumer identifier 404) corresponding to the consumer 102. In one embodiment, the request for information may further include at least one profiling segment (e.g., profiling segment 506). In step 906, a processing device (e.g., the processing unit 204) may identify browsing information (e.g., the browsing information 504) associated with the consumer 102, wherein the browsing information 504 includes information corresponding to at least two merchant web sites. In one embodiment, the at least two merchant web sites may correspond to the at least two merchants involved in the plurality of financial transactions. In some embodiments, the browsing information 504 may include cookies.

In step 908, the processing device 204 may analyze the browsing information 504 and the transaction data entry 402 associated with the consumer 102 to identify a consumer profile (e.g., the consumer profile 502) associated with the consumer 102. In one embodiment, the identified consumer profile 502 may include at least one profiling segment 506. In a further embodiment, the at least one profiling segment 506 may be the at least one profiling segment included in the request for information. In one embodiment, the consumer profile 502 may include spending behaviors. In an exemplary embodiment, the consumer profile 502 (e.g., the profiling segments 506) may include at least one of: interest index, frequency of clicks, price sensitivity, shipping cost sensitivity, discretionary spending, and affluence index. In step 910, the consumer profile 502 may be transmitted to the merchant 108 by a transmitting device (e.g., the transmitting unit 206). Exemplary Method for Displaying a Customized Web Page to a User

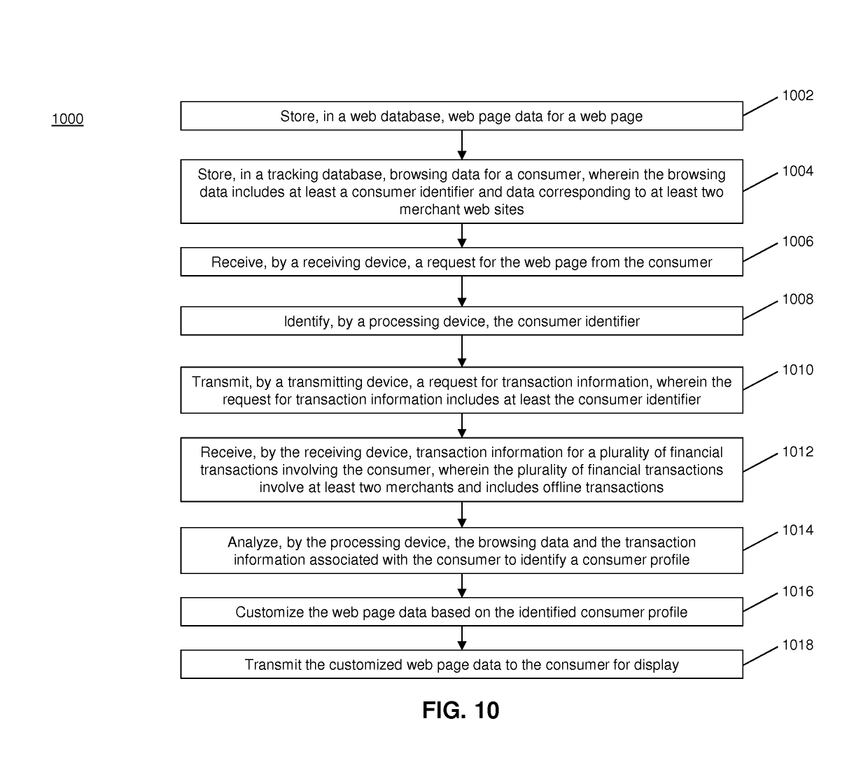

FIG. 10 illustrates a method 1000 for displaying a customized web page to a user based on a consumer profile.

In step 1002, web page data for a web page may be stored in a web database (e.g., the web database 106). In step 1004, browsing data for a consumer (e.g., the consumer 102) may be stored in a tracking database (e.g., the tracking database 107), wherein the browsing data includes at least a consumer identifier (e.g., the consumer identifier 404) and data corresponding to at least two merchant web sites. In one embodiment, the browsing data may include cookies. In step 1006, a receiving device (e.g., the receiving unit 302) may receive a request for the web page from the consumer 102. In one embodiment, the web page request may be pursuant to the hypertext transfer protocol. In some embodiments, the request for the web page may include the consumer identifier 404.

In step 1008, the consumer identifier 404 may be identified by a processing device (e.g., the processing unit 304). In one embodiment, the consumer identifier 404 may be identified in the request for the web page. In another embodiment, identifying the consumer identifier 404 may include identifying a cookie including the consumer identifier 404. In a further embodiment, the cookie may be stored by the consumer 102. In step 1010, a transmitting device (e.g., the transmitting device 306) may transmit a request for transaction information (e.g., to the processing server 110), wherein the request for transaction information includes at least the consumer identifier 404. In one embodiment, the request for transaction information may further include merchant identifiers corresponding to the at least two merchant web sites.

In step 1012, transaction information for a plurality of financial transactions (e.g., financial transactions 402) involving the consumer 102 may be received by the receiving device 302, wherein the plurality of financial transactions 402 involves at least two merchants and includes offline transactions. In one embodiment, the at least two merchants may correspond to the at least two merchant web sites of the browsing data. In step 1014, the processing device 304 may analyze the browsing data and the transaction information associated with the consumer 102 to identify a consumer profile (e.g., the consumer profile 502). In one embodiment, the consumer profile 502 may include at least one of: interest index, frequency of clicks, price sensitivity, shipping cost sensitivity, discretionary spending, and affluence index.

In step 1016, the web page data may be customized based on the identified consumer profile 502. In step 1018, the customized web page data may be transmitted to the consumer 102 for display. In some embodiments, the method 1000 may further include transmitting, to a merchant (e.g., the merchant 108), the consumer profile 502 and receiving, from the merchant 108, web data based on the transmitted consumer profile 502, wherein the customized web page data includes the received web data. In a further embodiment, the merchant 108 may be included in the at least two merchants or may correspond to one of the at least two merchant web sites.

### Exemplary Method of Reporting Consumer Keyword Data to a Merchant

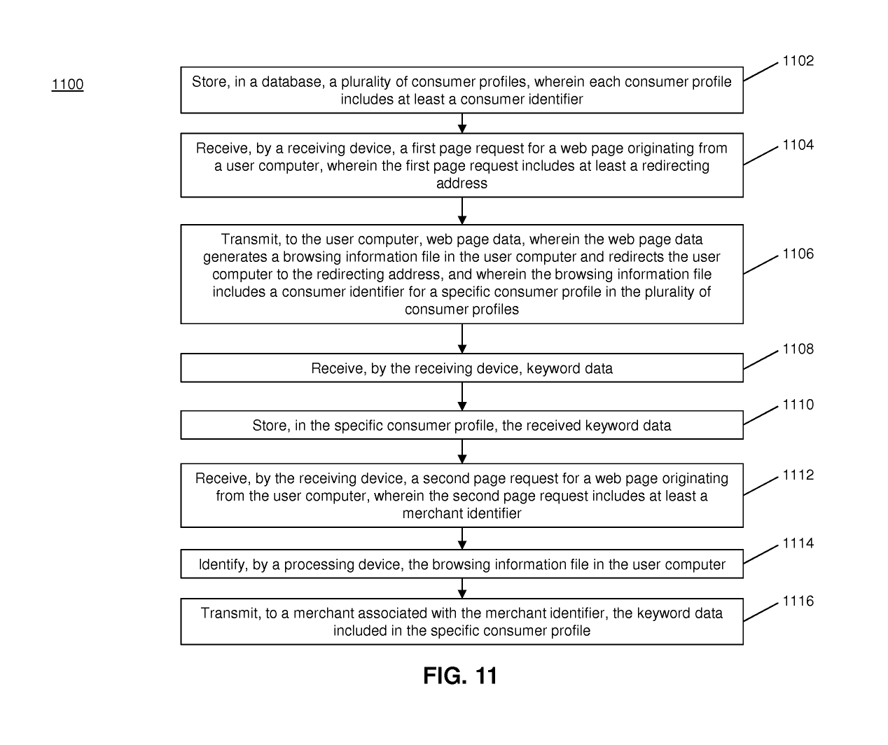

FIG. 11 illustrates a method 1100 for reporting consumer keyword data to a merchant. In step 1102, a plurality of consumer profiles (e.g., consumer profiles 502) may be stored in a database (e.g., the profile database 114), wherein each consumer profile includes at least a consumer identifier (e.g., the consumer identifier 404). In step 1104, a receiving device (e.g., the receiving unit 202 or 302) may receiving a first page request for a web page originating from a user computer (e.g., the consumer 102), wherein the first page request includes at least a redirecting address.

In step 1106, a transmitting device (e.g., the transmitting unit 206 or 306), may transmit, to the user computer 102, web page data, wherein the web page data generates a browsing information file in the user computer 102 and redirects the user computer 102 to the redirecting address, and wherein the browsing information file includes a consumer identifier 504 for a specific consumer profile 502 in the plurality of consumer profiles. In one embodiment, the browsing information file may be a cookie. In step 1108, the receiving device may receive keyword data. In step 1110, the received keyword data may be stored in the specific consumer profile 502 (e.g., as browsing information, such as the browsing information 504).

In step 1112, the receiving device may receive a second page request for a web page originating from the user computer 102, wherein the second page request includes at least a merchant identifier. In one embodiment, the first page request may be received from a first merchant, and the second page request may be received from a second merchant. In step 1114, a processing device may identify the browsing information file in the user computer 102. Then, in step 1116, the keyword data included in the specific consumer profile 502 may be transmitted to a merchant associated with the merchant identifier.

In one embodiment, the method 1100 may further include analyzing the keyword data to identify at least one profiling segment or indicia and storing, in the specific consumer profile 502, the identified at least one profiling segment or indicia. In another embodiment, the method 1100 may further include: receiving transaction data for a plurality of financial transactions involving a consumer associated with the consumer identifier 504 in the specific consumer profile 502 and at least two merchants; analyzing the received transaction data and the keyword data to identify at least one profiling segment or indicia associated with the consumer; storing, in the specific consumer profile 502, the identified at least one profiling segment or indicia; and transmitting, to the merchant associated with the merchant identifier, at least one profiling segment or indicia.

Techniques consistent with the present disclosure provide, among other features, systems and methods for reporting consumer profiles to merchants, displaying customized web page data to users, and reporting consumer keyword data to a merchant. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method of reporting a consumer profile to a merchant, comprising:
storing, in a database, a plurality of transaction data entries, wherein each transaction data entry is associated with a consumer and includes a plurality of financial transactions, the plurality of financial transactions involving at least two merchants and including offline transactions;
receiving, from a merchant, a request for information, wherein the request for information includes at least a consumer identifier corresponding to the consumer;
identifying, by a processing device, browsing information associated with the consumer, wherein the browsing information includes information corresponding to at least two merchant web sites;
analyzing, by the processing device, the browsing information and the transaction data entry associated with the consumer to identify a consumer profile associated with the consumer; and
transmitting, by a transmitting device, the consumer profile to the merchant.

2. The method of claim 1, wherein the at least two merchants includes the merchant.

3. The method of claim 1, wherein the request for information further includes at least one profiling segment or indicia.

4. The method of claim 3, wherein the consumer profile includes at least the at least one profiling segment or indicia.

5. The method of claim 1, wherein the consumer profile includes at least spending behaviors.

6. The method of claim 1, wherein the at least two merchant web sites correspond to the at least two merchants.

7. The method of claim 1, wherein the browsing information includes cookies.

8. The method of claim 1, wherein the consumer profile includes at least one of interest index, frequency of clicks, price sensitivity, shipping cost sensitivity, discretionary spending, and affluence index.

9. A method of displaying a customized web page to a user, comprising:
storing, in a web database, web page data for a web page;
storing, in a tracking database, browsing data for a consumer, wherein the browsing data includes at least a consumer identifier and data corresponding to at least two merchant web sites;
receiving, by a receiving device, a request for the web page from the consumer;
identifying, by a processing device, the consumer identifier;
transmitting, by a transmitting device, a request for transaction information, wherein the request for transaction information includes at least the consumer identifier;
receiving, by the receiving device, transaction information for a plurality of financial transactions involving the consumer, wherein the plurality of financial transactions involve at least two merchants and includes offline transactions;
analyzing, by the processing device, the browsing data and the transaction information associated with the consumer to identify a consumer profile;
customizing the web page data based on the identified consumer profile; and
transmitting the customized web page data to the consumer for display.

10. The method of claim 9, further comprising:
transmitting, to a merchant, the consumer profile; and
receiving, from the merchant, web data based on the transmitted consumer profile,
wherein the customized web page data includes the received web data.

11. The method of claim 10, wherein the at least two merchants includes the merchant.

12. The method of claim 9, wherein the at least two merchant web sites correspond to the at least two merchants.

13. The method of claim 9, wherein the browsing data includes cookies.

14. The method of claim 9, wherein identifying the consumer identifier includes identifying a cookie including the consumer identifier.

15. The method of claim 9, wherein the consumer profile includes at least one of interest index, frequency of clicks, price sensitivity, shipping cost sensitivity, discretionary spending, and affluence index.

16. A method of reporting consumer keyword data to a merchant, comprising:
storing, in a database, a plurality of consumer profiles, wherein each consumer profile includes at least a consumer identifier;
receiving, by a receiving device, an initial data request originating from a user computer, wherein the initial data request includes at least a redirecting address;
transmitting, to the user computer, data, wherein the transmitted data generates a browsing information file in the user computer and redirects the user computer to the redirecting address, and wherein the browsing information file includes a consumer identifier for a specific consumer profile in the plurality of consumer profiles;
receiving, by the receiving device, keyword data;
storing, in the specific consumer profile, the received keyword data;
receiving, by the receiving device, a subsequent data request originating from the user computer, wherein the subsequent data request includes at least a merchant identifier;
identifying, by a processing device, the browsing information file in the user computer; and
transmitting, to a merchant associated with the merchant identifier, the keyword data included in the specific consumer profile.

17. The method of claim 16, further comprising:
analyzing, by the processing device, the keyword data to identify at least one profiling segment or indicia;
storing, in the specific consumer profile, the identified at least one profiling segment or indicia; and
transmitting, to the merchant associated with the merchant identifier, the identified at least one profiling segment or indicia.

18. The method of claim 16, further comprising:
receiving, by a receiving device, transaction data for a plurality of financial transactions involving a consumer associated with the consumer identifier in the specific consumer profile and at least two merchants;
analyzing the received transaction data and the keyword data to identify at least one profiling segment or indicia associated with the consumer;
storing, in the specific consumer profile, the identified at least one profiling segment or indicia; and
transmitting, to the merchant associated with the merchant identifier, the identified at least one profiling segment or indicia.

19. The method of claim 16, wherein the browsing information file is a cookie.

20. The method of claim 16, wherein the subsequent data request is a web page request.

21. A system for reporting a consumer profile to a merchant, comprising:
a database configured to store a plurality of transaction data entries, wherein each transaction data entry is associated with a consumer and includes a plurality of financial transactions, the plurality of financial transactions including at least two merchants and including offline transactions;
a receiving device configured to receive, from a merchant, a request for information, wherein the request for information includes at least a consumer identifier corresponding to the consumer;
a processing device configured to
identify browsing information associated with the consumer, wherein the browsing information includes information corresponding to at least two merchant web sites, and
analyze the browsing information and the transaction data entry associated with the consumer to identify a consumer profile associated with the consumer; and
a transmitting device configured to transmit the consumer profile to the merchant.

22. The system of claim 21, wherein the at least two merchants includes the merchant.

23. The system of claim 21, wherein the request for information further includes at least one profiling segment or indicia.

24. The system of claim 23, wherein the consumer profile includes at least the at least one profiling segment or indicia.

25. The system of claim 21, wherein the consumer profile includes at least spending behaviors.

26. The system of claim 21, wherein the at least two merchant web sites correspond to the at least two merchants.

27. The system of claim 21, wherein the browsing information includes cookies.

28. The system of claim 21, wherein the consumer profile includes at least one of interest index, frequency of clicks, price sensitivity, shipping cost sensitivity, discretionary spending, and affluence index.

29. A system for displaying a customized web page to a user, comprising:
a web database configured to store web page data for a web page;
a tracking database configured to store browsing data for a consumer, wherein the browsing data includes at least a consumer identifier and data corresponding to at least two merchant web sites;
a receiving device configured to receive a request for the web page from the consumer;
a processing device configured to identify the consumer identifier; and
a transmitting device configured to transmit a request for transaction information, the request for transaction information including at least the consumer identifier, wherein
the receiving device is further configured to receive transaction information for a plurality of financial transactions including the consumer, the plurality of financial transactions including at least two merchants and including offline transactions, and
the processing device is further configured to
analyze the browsing data and the transaction information associated with the consumer to identify a consumer profile,
customize the web page data based on the identified consumer profile, and
cause the transmitting device to transmit the customized web page data to the consumer for display.

30. The system of claim 29, wherein
the transmitting device is further configured to transmit, to a merchant, the consumer profile; and
the receiving device is further configured to receive, from the merchant, web data based on the transmitted consumer profile,
wherein the customized web page data includes the received web data.

31. The system of claim 30, wherein the at least two merchants includes the merchant.

32. The system of claim 29, wherein the at least two merchant web sites correspond to the at least two merchants.

33. The system of claim 29, wherein the browsing information includes cookies.

34. The system of claim 29, wherein identifying the consumer identifier includes identifying a cookie including the consumer identifier.

35. The system of claim 29, wherein the consumer profile includes at least one of interest index, frequency of clicks, price sensitivity, shipping cost sensitivity, discretionary spending, and affluence index.

36. A system for reporting a consumer keyword data to a merchant, comprising:
a database configured to store a plurality of consumer profiles, wherein each consumer profile includes at least a consumer identifier;
a receiving device configured to receive an initial data request originating from a user computer, wherein the initial data request includes at least a redirecting address;
a transmitting device configured to transmit, to the user computer, data, wherein the data generates a browsing information file in the user computer and redirects the user computer to the redirecting address, and wherein the browsing information file includes a consumer identifier for a specific consumer profile in the plurality of consumer profiles; and
a processing device configured to
cause the receiving device to receive keyword data,
store, in the specific consumer profile, the received keyword data,
cause the receiving device to receive a subsequent data request originating from the user computer, wherein the subsequent data request includes at least a merchant identifier, and
identify the browsing information file in the user computer,
wherein the transmitting device is further configured to transmit, to a merchant associated with the merchant identifier, the keyword data included in the specific consumer profile.

37. The system of claim 36, wherein the processing device is further configured to
analyze the keyword data to identify at least one profiling segment or indicia;
store, in the specific consumer profile, the identified at least one profiling segment or indicia; and
cause the transmitting device to transmit, to the merchant associated with the merchant identifier, the identified at least one profiling segment or indicia.

38. The system of claim 36, wherein
the receiving device is further configured to receive transaction data for a plurality of financial transactions involving a consumer associated with the consumer identifier in the specific consumer profile and at least two merchants;
the processing device is further configured to analyze the received transaction data and the keyword data to identify at least one profiling segment or indicia associated with the consumer, and store, in the specific consumer profile, the identified at least one profiling segment or indicia; and
the transmitting device is further configured to transmit, to the merchant associated with the merchant identifier, the identified at least one profiling segment or indicia.

39. The system of claim 36, wherein the browsing information file is a cookie.

40. The system of claim 36, wherein the subsequent data request is a web page request.
